(19) United States
(12) Patent Application Publication
(10) Pub. No.: US 2010/0088766 A1
(43) Pub. Date: Apr. 8, 2010

(54) METHOD AND SYSTEM FOR DETECTING, BLOCKING AND CIRCUMVENTING MAN-IN-THE-MIDDLE ATTACKS EXECUTED VIA PROXY SERVERS

(75) Inventors: Rony Michaely, Haifa (IL); Ofer Elzam, Kiriat Haim (IL); Moshe Brody, Kfar Sava (IL)

Correspondence Address: DARBY & DARBY P.C., P.O. BOX 770, Church Street Station, New York, NY, 10008-0770, US

(73) Assignee: Aladdin Knoweldge Systems Ltd., Petach Tikva (IL)

(21) Appl. No.: 12/247,602

(22) Filed: Oct. 8, 2008

(51) Int. Cl. G06F 21/00

(52) U.S. Cl. 726/23

(57) ABSTRACT

A method for detecting and blocking a Man-in-the-Middle phishing attack carried out on a client connection which has been fraudulently routed through an anonymous proxy server. An agent downloaded to the client device opens a client direct connection to the security host protecting against the attack and sends a client direct connection ID to the security host for validation. By comparing IP addresses correlated via the validated client direct connection ID, the security host determines whether the original connection is direct (secure) or indirect (attack via phishing proxy). The detection and blocking can be performed by the service provider's server or by a third-party validation server handling all security without additional requirements on the service provider server. In addition to detecting and blocking such attacks, methods for client direct connection ID, as well as automatic transparent and seamless attack circumvention and preemptive circumvention are disclosed.

### FIELD OF THE INVENTION

The present invention relates to increasing computer network security, and, more particularly, to a method for detecting, blocking, and circumventing the use of a proxy server to carry out a man-in-the-middle phishing attack.

### BACKGROUND OF THE INVENTION

Computer networks, such as the Internet, are increasingly used to perform sensitive data operations, such as on-line financial reporting and transactions. A standard way of providing security for such operations is to employ a secure session between a client and a server, such as via the Secure Socket Layer (SSL) as illustrated in a non-limiting example in FIG. 1.

In the simplified conceptual diagram of FIG. 1, a user 101 wishes to connect to a service provider server of sensitive and/or confidential information, herein exemplified by a bank 103 with which user 101 has an account. The term “service provider” herein denotes any entity which provides a service to a user over a network (such as the Internet). The service provider furnishes a server on the network to handle interaction with user computers. Non-limiting examples of service providers include: banks and other financial institutions; Internet service providers; subscription service providers; news services; and information services. Typically, it is intended by the service provider and the user that the network connection between the service provider's server and the user's client computer be secure from eavesdropping and attack.

User 101 enters a Universal Resource Locator (URL) 105 into a computer 107 connected to the Internet 109, so that computer 107 will communicate over a secure channel 111 to a bank server 113 having URL 105. Using SSL, computer 107 is connected to bank server 113 in a way that communication on channel 111 is encrypted so that only computer 107 and bank server 113 can read the communications, thereby blocking an intruder 115 from reading the contents of the communication. Moreover, no external party, such as intruder 115, can modify or insert material into channel 111 without being detected, nor can any such modifications or insertions have any detrimental effect. To assure user 101 that the session is safe, computer 107 displays a web page 117 of bank 103 with indicia 119 to signify that channel 111 is secure against network-based attack. Secure channels are implemented via encrypted communications over regular network connections.

The term “network connection” herein denotes a virtual circuit over a network, and a “network connection” between two entities over the network does not imply that there exists a physical connection between those entities. A network connection may include more than one successive virtual circuit; a “direct network connection” is a special kind of network connection, as described below. The term “network communication” herein denotes a transmission/reception of one or more data packets over a network connection.

Provided that user 101 correctly enters URL 105 directly into computer 107, the above scenario reliably guarantees that the user session with the bank (or other sensitive service provider site) is safe.

Direct entry of a URL (via typing), however, can be time-consuming and error-prone, and thus users typically prefer entering a URL by clicking on a link in a document or file. Unfortunately, not all links can be trusted. A link entered by a user and kept in a “favorites” or “bookmarks” list, for example, is usually trustworthy, but the convenience and ease of disseminating links via the web and e-mail has created a situation where many links which superficially appear authentic are actually malicious. A user is liable to employ a malicious link without realizing the consequences.

FIG. 2 conceptually illustrates an attack that can be carried out on an unsuspecting user 201, who also wishes to connect to a sensitive network site, herein also exemplified by bank 103, with which user 201 has an account. However, instead of entering URL 105 directly into a computer 203, user 201 clicks on a link 213 with the intention and expectation of entering URL 105. User 201 has received link 213 in an e-mail message 209 which he believes to have come from bank 103 because indicia 211 appearing in e-mail message 209 conveys the impression that this is the case.

Unfortunately, however, e-mail message 209 is a forgery which has been sent out in a mass-mailing (e.g., “spam”) by an attacker for the purpose of fraudulently routing the user's network connection through an anonymous proxy server for the purpose of obtaining sensitive information about user accounts at bank 103. E-mail 209 is marked with indicia 211 and other representations to fool users into trusting link 213, i.e., that the URL of link 213 is to bank 103. In fact, however, link 213 is not URL 105, and instead connects computer 203 to an anonymous proxy server 207, which is manipulated by an attacker via a remote computer 205. If user 201 were sophisticated and knowledgeable regarding Internet addressing, and were to carefully inspect the URL contained in link 213 in comparison with URL 105, he might detect the discrepancy. A clever attacker, however, can disguise the anonymous proxy URL referenced by link 213 in various ways to induce the unwary user to click on link 213. Primarily, the text associated with link 213 as displayed to the user in e-mail 209 may convincingly misrepresent that link 213 goes to bank 103. In addition, an attacker will typically embed references to bank 103 in a complex URL. Many legitimate URLs are lengthy and complex, and contain references which are meaningless to a human user. A user who sees the name of the intended site appearing inside a lengthy and complex URL may therefore assume that the URL is legitimate. Even sophisticated users may ignore URLs and depend on the displayed text of links for guidance.

In any event, in the scenario which unfolds unwary user 201 is given additional (false) confidence that link 213 is trustworthy, as will be clear from the remaining discussion.

By clicking on link 213, user 201 initiates a connection between computer 203 and proxy server 207. It is possible that the attacker has even obtained a legitimate certificate for proxy server 207, so that proxy server 207 can authenticate itself to computer 203 and can thereby open a session via SSL over a secure channel 215. Secure channel 215 is optional and not necessary for carrying out the attack, although doing so conveys additional false confidence to user 201, as will be seen.

After having opened a connection between proxy server 207 and computer 203, the next step in the attack is to open a connection between proxy server 207 and bank server 113. Bank server 113 requires this connection to be secure, and is done via SSL over a secure channel 217. It is noted that SSL authenticates a server to the client, but does not authenticate the client to the server. In this case, proxy server 207 is the client to bank server 113, and thus proxy server 207 is not authenticated to bank server 113. Bank server 113 therefore has no way of knowing that proxy server 207 is not a legitimate proxy for computer 203.

After having opened connections via channel 215 and channel 217, the attack is ready to be executed. In essence, an indirect network connection is opened between computer 203 and bank server 113, whereby user 201 opens a session with bank 103. Thus, all the information supplied by bank server 113 reaches computer 203, and all the information supplied by user 201 reaches bank server 113. In this regard, user 201 has a complete session with bank 103 and can view and update all of his actual current account information, make transactions, and perform all other on-line activities permitted by bank 103. This fact alone is sufficient to convey to the typical user a high degree of (false) confidence that link 213 was legitimate and to allay any suspicion of fraud.

Direct Network Connection versus Indirect Network Connection

In the context of the above discussion, the term “direct network connection” between two devices on a network herein particularly denotes that a virtual circuit exists between the two devices such that the virtual circuit does not include any intermediate virtual circuits to any intermediate devices. In a direct network connection according to this definition, a session opened in accordance with the Secure Socket Layer (SSL) protocol will be secure from a Man-in-the-Middle attack, because there is no intermediate device in the middle. It is well-appreciated that in a connectionless packet-switching network (such as the Internet), data packets are necessarily handled by many intermediate devices. However, by virtue of the SSL data encryption over a direct network connection (as particularly defined hereinabove), none of the data is accessible to those other devices. In contrast, the term “indirect network connection” between two devices on a network herein particularly denotes that a virtual circuit exists between the two devices such that the virtual circuit does include at least one intermediate virtual circuit to at least one intermediate device. In an indirect network connection as particularly defined hereinabove, an intermediate virtual circuit to an intermediate device renders the indirect network connection vulnerable to a Man-in-the-Middle attack.

The above particular definitions of “direct network connection” and “indirect network connection” apply throughout the present application.

Returning to the discussion of FIG. 1, as part of the Man-in-the-Middle attack, authentic bank web page 117 appears on the screen of user computer 203. If the attacker has obtained a legitimate certificate for proxy server 207 and thereby opens an SSL session over secure channel 215, as previously mentioned, indicia 119 will appear on the screen to signify that channel 215 is secure against network-based attack. To the user, visible web page 117 as displayed is perfectly normal and is indistinguishable from a true secure session (FIG. 1), thereby confirming the user's (false) confidence in the legitimacy of link 213.

What unsuspecting user 201 does not realize, however, is that this is a “Man-in-the-Middle” attack, where the attacker is effectively between him and the bank, and is capable of monitoring all data transactions between them. The connection via proxy server 207 (FIG. 2) is an indirect connection to the bank, rather than a direct connection (FIG. 1). It is only while passing through channel 217 and (optionally) while passing through channel 215 that the data is secure. While the data is passing through proxy server 207, all communication between user 201 and bank server 113 is in plaintext, unencrypted, completely insecure, and totally accessible to the attacker. Thus, the attacker can record all the access information to the bank account of user 201, including the account number and password. After user 201 has ended his session, the attacker can employ the access information to successfully impersonate user 201 and obtain on-line access to the user's bank account. If, for example, bank 103 permits on-line transfer of funds to external accounts, such as for paying household bills, it may be possible for the attacker to steal money from the user's account by making fraudulent transfers to his own account.

This attack is a sophisticated version of earlier “phishing” attacks, where an attacker sets up a forged website to impersonate, say, a bank website and induce users to enter their account access information to the forged website. In these earlier phishing attacks, the attacker has to realistically simulate the bank website and provide a convincing scenario to the user which covers the fact that the forged website cannot simulate the user's actual account information. The Man-in-the-Middle attack is a far more serious threat because the attacker does not have to forge or simulate the bank website at all—the actual bank server itself provides the authentic website to the user. For these reasons, the anonymous proxy server Man-in-the-Middle attack is extremely dangerous. This attack affects not only users, but also operators of sensitive websites. Banks, for example, typically promote on-line banking transactions as being safe and secure. Banks may thus be held legally liable for losses incurred by users who rely on such assurances and are then victimized by anonymous proxy phishing attacks, which exploit faulty or inadequate bank security.

### Prior Art General Solutions to Phishing Attacks

Current prior-art solutions for detecting and combating this attack are inadequate. These include measures such as:
Browser interoperability with phishing site database
In this solution, each time the user attempts to access a site on the Internet, the browser checks the requested URL against a remote database of known phishing websites. If there is a match, the user is alerted with a warning.
First of all, such a solution requires a specially-configured browser with an agent or other capability to access a remote phishing site database. Even if such browsers become widespread, it can be expected that many users may still employ older browsers which lack this capability.
In addition, although this solution may be effective against older phishing websites which are forgeries of legitimate websites (provided such phishing sites are maintained in the database), it is readily seen that solutions depending on phishing site databases are ineffective against attacks utilizing anonymous proxies. Not only are proxy locations too numerous to efficiently monitor, but they are highly fluid and constantly changing. A database of such sites, even if compiled, would always be out-of-date.
Certificate-checking
It is well-known that the certificate of bank server 113 (FIG. 1 and FIG. 2) cannot be forged by the attacker, and therefore the attacker cannot rigorously impersonate the bank. By checking the certificate presented by proxy server 207 against the certificate information of bank server 113, it is easy to determine that computer 203 is not connected directly to bank server 113.
Nevertheless, this check is impractical to perform in practice, because the user's browser typically has no information about the bank or the bank website that the user intends to access. All the browser knows is the presented URL; the browser has no way of knowing that the URL of link 213 does not go to bank 103. In fact, the browser does not have any way of knowing that the user intends to connect to bank 103.
In addition, as previously noted, bank server 113 does not authenticate the client computer which opened the connection, not even in an SSL session, and it may not be advantageous to do so. Many users do not want to be restricted to a single client when to connecting to websites of their banks (and other sensitive websites). When traveling, these users want to be able to connect via whatever Internet client facilities may be available locally (such as at hotels, airports, coffee shops, etc.). If bank server 113 were to require authentication for the client, the ability of the users to make such connections might be hindered or blocked completely.
Hardware tokens
In this solution, the user employs a hardware token which contains certificates and is equipped with a high-security cryptographic engine. The user plugs the hardware token into his or her computer, and the token opens a secure, authenticated session with the bank server (or other sensitive website). Such a solution is secure against Man-in-the-Middle attacks (such as anonymous proxy phishing), because the entire session is encrypted end-to-end regardless of how the connection is opened and regardless of whether the connection is an indirect network connection, by virtue of the fact that both the bank server and the hardware token mutually authenticate themselves and open a secure session.
The hardware token thus solves the problem of full authentication while allowing the users full portability and mobility.
Unfortunately, however, employing a hardware token involves considerably greater complexity than most service providers and users are willing to accept. In addition to the (not inconsiderable) cost of the hardware token itself, there are the challenges of managing the issuing and maintenance of the hardware tokens on the part of the service provider, and the lifestyle adjustments the users have to make to carry it on their persons at all times. Furthermore, even though managing and carrying a single hardware token might be acceptable to many users, managing and carrying multiple hardware tokens from multiple service providers is a serious obstacle. This could be overcome by standardizing a single hardware token to be usable by multiple service providers, but this, too, has its challenges and shortcomings.

### Prior Art Method for a Detecting a Man-in-the-Middle Attack

FIG. 3 illustrates a prior-art method for detecting a Man-in-the-Middle attack, as disclosed in United States Patent Application publication US 2008/0104672 of Lunde, et al. (“Lunde”). User computer 203 is connected via network connection 325 to proxy 207 controlled by attacker computer 205. Proxy 207 is connected via a network connection 327 to a service provider server 300, thereby allowing attacker computer access to plaintext of all communications between user computer 203 and service provider server 300. Attacker computer 205 and proxy 207 constitute the Man-in-the-Middle.

It is understood that to detect a Man-in-the-Middle attack, it is sufficient to detect that there is a Man-in-the-Middle. That is, the security breach itself is cause for taking action.

In order to detect a Man-in-the-Middle, the prior-art solution of Lunde as illustrated in FIG. 3 utilizes an anti-fraud server 301 which is connected to user computer 203 via a network connection 303, preferably prior to a Man-in-the-Middle attack. Anti-fraud server 301 downloads an agent 305, which can collect from user computer 203 device-specific data 307 relating thereto, and then send device-specific data 307 to anti-fraud server via network connection 303. Agent 305 can be an ActiveX control or a browser plug-in, for example. Service provider server 300 is programmed to remotely activate agent 305 upon receiving a session login request from user computer 203. Thus, when user computer 203 attempts session login at service provider server 300, agent 305 sends device-specific data 307 of user computer 203 to anti-fraud server 301 in a network communication 309. Anti-fraud server 301 receives network communication 309, from which is determined the IP address 311 of user computer 203. Then anti-fraud server 301 appends IP address 311 and a timestamp 313 to device-specific data 307, and returns device-specific data 307, IP address 311, and IP address 311 as encrypted data 315. Subsequently, when user computer 203 sends a network communication 317 to service provider server 300, encrypted data 315 is sent therewith over connection 327. Service provider server 300 then decrypts encrypted data 315 to obtain user computer 203's device-specific data 307 and user computer 203's IP address 311 along with timestamp 313. By comparing this information with the IP address of the sender of network communication 317, service provider server 300 is able to determine if there is a Man-in-the-Middle. Specifically, in the case illustrated in FIG. 3, IP address 329 of the sender of network communication 317 is that of proxy 207 (the Man-in-the-Middle). Thus, service provider server 300 compares IP address 329 with IP address 311 to detect that there is a Man-in-the-Middle. Timestamp 313 is also compared with the current time, and according to Lunde, an abnormal delay may also indicate the presence of a Man-in-the-Middle. In the event a Man-in-the-Middle is detected, service provider server 300 refuses the session login from user computer 203, thereby preventing the opportunity for an attack.

A shortcoming to this prior-art scheme is the need to manage data 315, whether encrypted or not. The need to collect device-specific data and return such data to the user computer places an additional burden on the communications. Furthermore, device-specific data may not be relevant in cases where the user utilizes a different device for obtaining services over a network, such as when traveling.

Another shortcoming in this prior-art scheme is the need for sending IP address information back to the client device, which in turn must embed this information into the session login request being sent to the service provider server. Additional overhead imposed by this step includes the encryption and decryption of the client IP address information.

Yet another shortcoming in this prior-art scheme is the requirement for substantial modifications to the network protocol. In particular, service provider server 300 must accommodate additional protocol transactions with client 203 in order to initiate the above-described actions of agent 305; decrypt data 315, get the IP address of the sender, compare this IP address with the decrypted IP address 311 of the client, and based on the comparison decide whether to continue with the session or to abort the session.

A further shortcoming in this prior-art scheme is that there is provided no means of circumventing a detected Man-in-the-Middle attack. At most, when the attack is detected, the prior-art scheme provides for terminating the session and notifying the client. This shortcoming further causes inconvenience and concern to the user and undermines user faith in the safety of on-line transactions.

There is thus a need for, and it would be highly advantageous to have, a method and system for detecting and blocking Man-in-the-Middle attacks which does not suffer from the aforementioned shortcomings. This goal is met by the present invention.

### SUMMARY OF THE INVENTION

The present invention is of a method and system for detecting and blocking anonymous proxy Man-in-the-Middle attacks using existing networking technologies.

The term “client device” herein denotes any device connected to a network, typically for obtaining services from a provider of services on the network, and typically for employment by a user thereof. Client devices include, but are not limited to: user computers; workstations; terminals; and the like.

It is an objective of the present invention to detect and block anonymous proxy phishing attacks from the server of the service provider (and/or from a server of a trusted third party), and without relying on the user or the user's browser facilities in any manner. That is, according to the present invention, the service provider can reasonably guarantee that all anonymous proxy phishing attacks and other Man-in-the-Middle attacks can be detected and blocked regardless of the ability (or lack thereof) of the user or the user's browser to recognize and respond to such attacks.

It is also an objective of the present invention to detect and block Man-in-the-Middle attacks without requiring identification or specific hardware characterization of the user's computer, and without requiring a timestamp.

It is a further objective of the present invention to detect and block Man-in-the-Middle attacks without requiring sending client IP address information back to the client, without encrypting client IP address information, and without decrypting client IP address information.

According to embodiments of the present invention, this is accomplished in a fully automated and deterministic manner by the service provider server, optionally in conjunction with a trusted third-party server.

According to embodiments of the present invention, the detection of an anonymous proxy Man-in-the-Middle relies on the fact that the IP address of a client connected to a server is known to the server. Thus, according to these embodiments of the present invention, the server, by causing a direct secondary connection to be opened between the client computer and the server, can compare the client IP address thereof to the client IP address of the primary connection. If the two client IP addresses are the same, then the server knows that the primary connection is a direct connection and that the SSL connection is between the server and the client, and is secure. If, however, the two client IP addresses are not the same, then the server knows that the primary connection is an indirection connection via an anonymous proxy server, in which case the SSL connection is between the server and the anonymous proxy, and is therefore insecure. In the latter case, the server can block the Man-in-the-Middle attack by severing the primary connection prior to the exchange of any sensitive information.

The causing of a direct secondary connection to be opened between the client computer and the server is accomplished in a variety of ways in the various embodiments of the present invention, as discussed below.

New Features over the Prior Art, and Benefits Thereof

Embodiments of the present invention have novel features which are neither disclosed nor reasonably suggested by the prior art.

In particular, according to embodiments of the present invention, the detection of a Man-in-the-Middle attack is effected entirely by a validation server acting on behalf of a service provider without the need to equip the service provider server with any additional capabilities. The present invention therefore offers extra security without requiring any changes in existing network infrastructure.

### Security Host

The term “security host” herein denotes any device which performs a given method of the present invention to protect against a Man-in-the-Middle attack, including, but not limited to a server on a network. Being a security host is not exclusive to other functions; a device acting as a security host can also provide other services.

Embodiments of the present invention provide for security against a Man-in-the-Middle attack by validating a client direct connection ID for a network connection opened by a client device to a security host, in a manner which is neither disclosed nor reasonably suggested by the prior art.

Moreover, embodiments of the present invention provide for circumventing a Man-in-the-Middle attack in a manner that is completely transparent to the user. The present invention thus avoids user distress and concern that results from prior art solutions, which offer no alternative to simply terminating the client device's connection to block a detected Man-in-the-Middle attack. This circumventing capability of embodiments of the present invention is neither disclosed nor reasonably suggested by the prior art.

Furthermore, embodiments of the present invention provide for preemptively circumventing a Man-in-the-Middle attack, in a manner that prevents a Man-in-the-Middle attack from being initiated—and which therefore obviates the need to even detect a Man-in-the-Middle attack. This is also performed in a manner that is completely safe and transparent to the user, and which is neither disclosed nor reasonably suggested by the prior art.

Therefore, according to the present invention there is provided a method for detecting a Man-in-the-Middle attack during a session over a network connection between a client device having an IP address and a security host, the method including: (a) installing an agent within the client device, wherein the agent is configured to open a direct network connection to the security host; (b) receiving, by the security host, of an original connection from the client device for a session login request, the original connection having a sender with a sender IP address; (c) determining, by the security host, of the sender IP address; (d) sending, by the security host to the agent, a client direct connection ID request; (e) opening, by the agent, a new direct network connection from the client device to the security host; (f) generating, by the agent, a client direct connection ID in response to the request, and sending the client direct connection ID to the security host via the direct network connection; (g) determining, by the security host, of the IP address of the client device according to the new direct network connection; (h) comparing, by the security host, the IP address of the client device and the sender IP address according to the client direct connection ID; and (i) if according to the comparison the sender IP address does not match the IP address of the client device, then issuing a notification that a Man-in-the-Middle attack has been detected.

In addition, according to the present invention there is provided a method for preemptively circumventing a Man-in-the-Middle attack during a session over a network connection between a client device and a security host, the method including: (a) installing an agent within the client device, wherein the agent is configured to open a direct network connection to the security host; (b) receiving, by the security host, an original network connection opened by the client device for the session between the client device and the security host; (c) signaling, by the security host, the agent to open a new direct network connection to the security host; (d) validating, by the security host, that the new direct network connection is a direct network connection; (e) signaling to switch the session from the original network connection to the new direct network connection; (f) switching, by the security host to the new direct network connection; (g) terminating, by the security host of the original network connection; (h) switching, by the agent to the new direct network connection; (i) terminating, by the agent of the original network connection; and (j) continuing the session over the new direct network connection.

Furthermore, according to the present invention there is provided a method for authenticating a network connection between a security host and a client device as a direct network connection, to protect against a Man-in-the-Middle attack, the method including: (a) installing an agent within the client device; (b) sending, by the security host, a client direct connection ID request to the agent; (c) opening, by the agent, a direct network connection to the security host; (d) generating, by the agent, a client direct connection ID in response to the client direct connection ID request; (e) sending, by the agent, the client direct connection ID to the security host over the direct network connection; (f) receiving, by the security host, the client direct connection ID; and (g) validating, by the security host; the client direct connection ID; (h) thereby authenticating the direct network connection as a direct network connection.

### BRIEF DESCRIPTION OF THE DRAWINGS

The invention is herein described, by way of example only, with reference to the accompanying drawings, wherein:

FIG. 1 is a simplified conceptual configuration diagram of a prior-art secure session over a network using SSL.

FIG. 2 is a simplified conceptual configuration diagram of a prior-art Man-in-the-Middle attack by an anonymous proxy.

FIG. 3 is a conceptual configuration diagram of a prior-art solution for detecting a Man-in-the-Middle attack.

FIG. 4 is a conceptual configuration diagram of a solution for detecting a Man-in-the-Middle attack according to an embodiment of the present invention.

FIG. 5A is a conceptual configuration diagram of a validation server for furnishing protection against a Man-in-the-Middle attack to a service provider server according to another embodiment of the present invention.

FIG. 5B is a conceptual configuration diagram of the validation server of FIG. 5A during a Man-in-the-Middle attack.

FIG. 6 is a flowchart of a method for detecting a Man-in-the-Middle attack according to an embodiment of the present invention.

FIG. 7 is a flowchart of a method for circumventing a Man-in-the-Middle attack according to an embodiment of the present invention.

FIG. 8A is a conceptual configuration diagram of a circumvention of a Man-in-the-Middle attack according to an embodiment of the present invention.

FIG. 8B is a conceptual configuration diagram of a circumvention of a Man-in-the-Middle attack according to another embodiment of the present invention.

FIG. 9 is a flowchart of a method according to an embodiment of the present invention for authenticating a direct network connection opened by a client device agent to a security host, to protect against a potential Man-in-the-Middle attack.

FIG. 10 is a flowchart of a method according to an embodiment of the present invention for preemptively circumventing a Man-in-the-Middle attack.

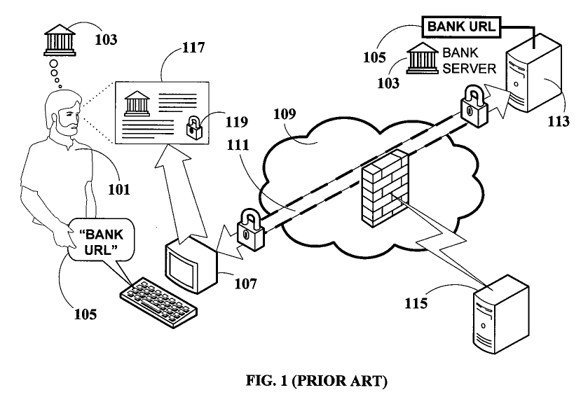

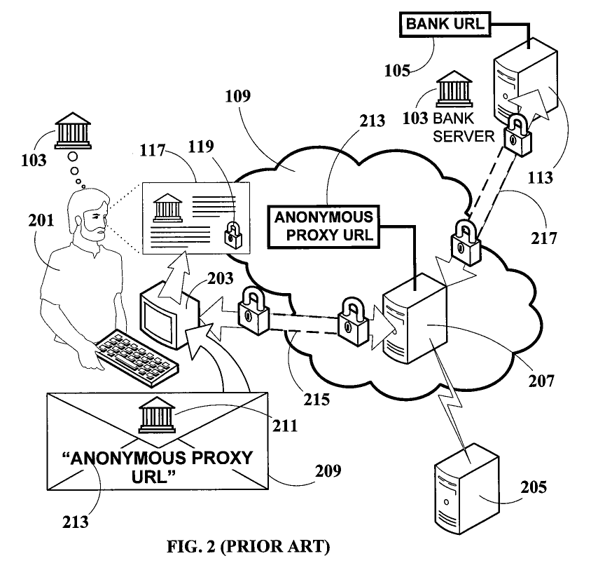

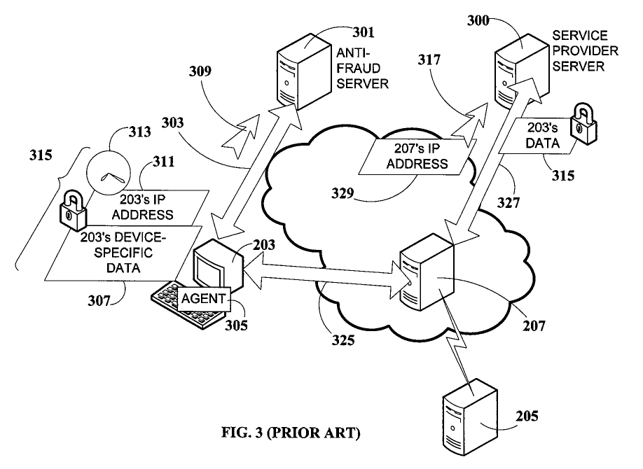

### DESCRIPTION OF THE PREFERRED EMBODIMENTS

The principles and operation of a method and system for detecting and blocking Man-in-the-Middle attacks via an anonymous proxy according to the present invention may be understood with reference to the drawings and the accompanying description.

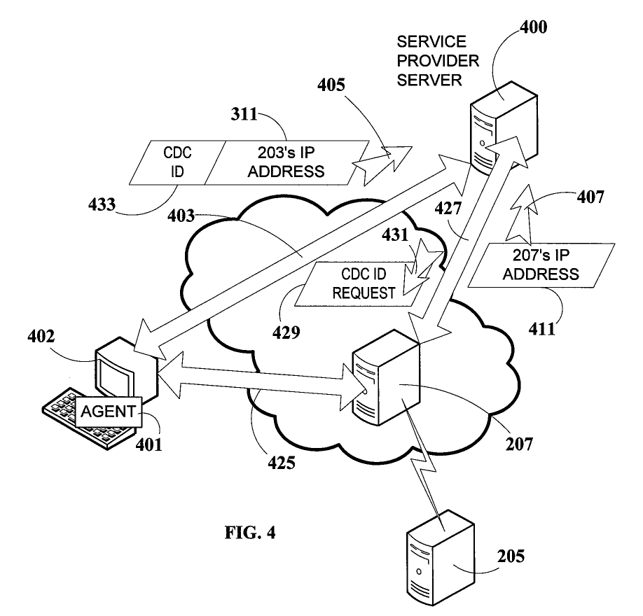

FIG. 4 is a conceptual configuration diagram of a solution for detecting a Man-in-the-Middle attack according to an embodiment of the present invention.

Client device 402 is connected to a service provider server 400, but has been fraudulently routed to anonymous proxy server 207 via a network connection 425, and thence to service provider server 400 via a network connection 427, thereby providing a security breach for a Man-in-the-Middle attack, as previously described. Normally, service provider server 400 has no way of knowing that connection 427 does not go directly to client device 402 but rather is routed through proxy server 207.

It is noted in passing that client devices are often connected to networks (such as the Internet) through a designated proxy, which handles all network communication for the client device. Such designated proxies are legitimate, in that their existence is known to the client device and/or to network administration personnel, and that these designated proxies provide valuable services to the client devices. In the context of the present invention, however, the client device is treated as if directly connected to the network whether or not there is a legitimate proxy involved. This simplification is done without loss of generality, because the client device is known throughout the network by IP address, and it does not matter whether this is the IP address of the client device via a direct connection to the network or the IP address via a legitimate designated proxy to the network. This consideration is also valid regardless of whether the designated proxy is a physical server on the network or a local proxy existing in software within the client device.

Returning now to FIG. 4, to detect the Man-in-the-Middle attack, an agent 401 is downloaded into client device 402. Agent 401 provides information to service provider server 400 which enables detection of the Man-in-the-Middle. Agent 401 includes executable software, non-limiting examples of which include: applets; scripts; browser plug-ins; and ActiveX controls.

According to embodiments of the present invention, agent 401 is typically a relatively simple piece of executable code. It is advantageous for agent 401 to be easily and quickly downloaded and installed in a client device. A benefit of the present invention is that the authentication required to attain a reasonable level of security (as described below in “Client Direct Connection ID (CDC ID) and Validation thereof”) can meet the present objectives without requiring strong cryptographic processes.

In a preferred embodiment of the present invention, downloading and installing agent 401 in the client device is done in advance, prior to the connecting of the client device to the security host for a session login request. In a non-limiting example, installing agent 401 can be done when the user opens up an account with the service provider using a session directly between client device 402 and service provider server 400. In this embodiment, agent 401 stays resident in client device 402 for future use.

### Downloading and Installing the Agent Over an Indirect Network Connection

In a related embodiment of the present invention, downloading and installing agent 401 in the client device is done subsequent to the connecting of the client device to the security host for a session login request. In a non-limiting example, installing agent 401 is done when client device 402 requests session login with service provider server 400, and is done over the existing indirect network connections 425 and 427. In this embodiment, agent 401 may need to be protected from capture and execution by anonymous proxy server 207. Such protection can be accomplished in various ways known in the art, such as by obfuscating the code of agent 401 so that the Man-in-the-Middle software will not recognize the code. Man-in-the-Middle attacks are typically aimed at recognizing and capturing user account information such as passwords, and are generally oblivious to the abundant executable code in interactive network sessions (such as a Java applet) which is intended for the user interface and display of web page information. Thus, there are well-known means in the art for preventing agent 401 from being exploited by a Man-in-the-Middle attacker.

When activated, agent 401 opens a direct network connection 403 with service provider server 400 (which may be an SSL connection) and sends a network communication 405 to service provider server 400, from which service provider server 400 determines client device 402's IP address 311.

In another related embodiment of the present invention, as part of the session login protocol, service provider server 400 sends a client direct connection ID (CDC ID) request 429 via a network communication 431 to agent 401. Upon receiving CDC ID request 429, agent 401 generates a client direct connection ID 433. Details of the CDC ID process are discussed below. When agent 401 opens direct network connection 403 with service provider server 400, client direct connection ID 433 is sent to service provider server 400 (such as in network communication 405) so that service provider server 400 can validate that connection 403 is direct and can associate IP address 311 with client device 402 during the session login.

From a network communication 407 which takes place over network connection 427, service provider server 400 determines the IP address 411 of anonymous proxy server 207. By comparing legitimate IP address 311 with IP address 411 and noting the mismatch thereof, service provider server 400 can determine that the present session via network connection 427 is not secure, and is vulnerable to a Man-in-the-Middle attack.

According to a further embodiment of the present invention, after detecting the potential Man-in-the-Middle attack, service provider server 400 blocks the attack by signaling agent 401 to terminate connection 425 and then terminating connection 427. The terms “terminate” and variations thereof with reference to a network connection herein denote that the connection is closed, disconnected, disabled, removed, or otherwise rendered inoperative and non-communicating. In yet another embodiment of the present invention (described below), upon detecting the potential Man-in-the-Middle attack, service provider server 400 circumvents the attack. In still another embodiment of the present invention (also described below), service provider server 400 preemptively circumvents a potential Man-in-the-Middle attack.

### Validation Server

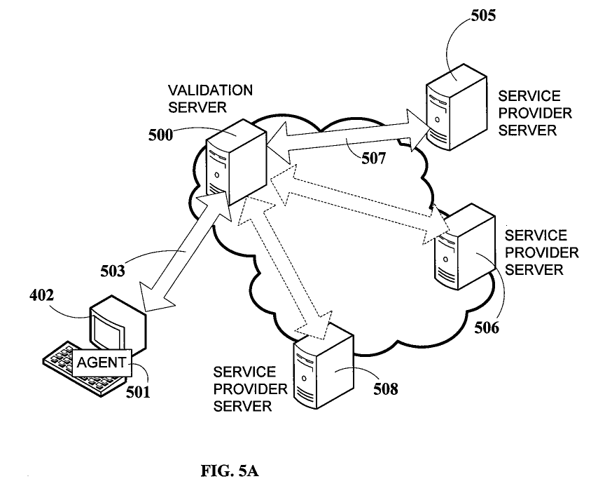

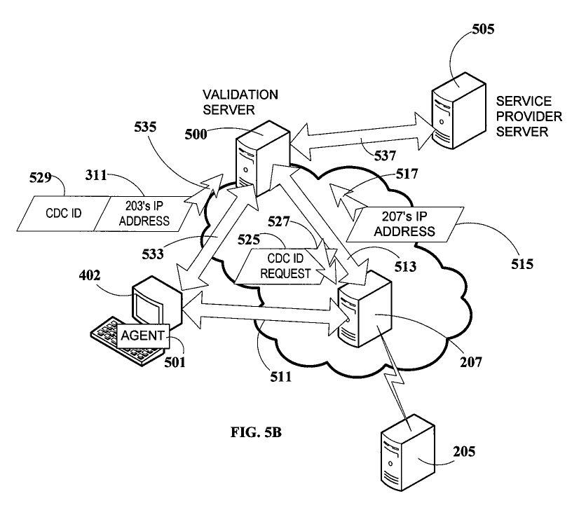

In embodiment of the present invention as shown in FIG. 4, agent 401 contains the IP address (or alternatively, the URL) of service provider server 400. In a further embodiment of the present invention, as shown in FIG. 5A, an agent 501 contains the IP address (or alternatively, the URL) of a validation server 500. In this embodiment, validation server 500 supports multiple service provider servers, such as a service provider server 505. In this embodiment of the present invention, service provider server 505 does not need to be concerned with any special protocols or security procedures. All special protocols and security procedures are handled by validation server 500 as a service for service provider server 505 and other such service provider servers. In this capacity, validation server 500 may be operated by a third-party vendor providing security to a multiplicity of service providers for a multiplicity of service provider servers, such as is illustrated in the non-limiting example of FIG. 5A for a service provider server 506 and a service provider server 508. For the configuration illustrated in FIG. 5A, service provider servers 505, 506, and 508 do not need any additional security provisions and can be completely oblivious to the special procedures needed to protect against Man-in-the-Middle attacks. All special security protocols and procedures required for protection against Man-in-the-Middle attacks are handled by validation server 500 as a security service to the respective service providers.

Discussion continues below, illustrating embodiments of the present invention with respect to service provider server 505.

Validation server 500 acts as a “front end” for service provider server 505. Typically, the URL associated with the service providers supported by validation server 500 are redirected to validation server 500. Thus, when the user wishes to contact server provider server 505, client device 402 first makes a connection 503 to validation server 500, after which validation server 500 opens a connection 507 to service provider server 505.

The connection to validation server 500 is transparent to the user, who sees the normal home-page of service provider server 505. Validation server 500 thus functions as a trusted proxy for service provider server 505 (as well as for other such service provider servers as illustrated in FIG. 5A). By virtue of the proxy status of validation server 500, various security functions can be provided to service provider server 505, particularly the detecting and preventing of Man-in-the-Middle attacks according to this embodiment of the present invention, as discussed below. As part of the security protection offered by this arrangement, validation server 500 downloads agent 501 to client device 402. As previously noted, agent 501 contains the IP address or URL of validation server 500.

Referring now to FIG. 5B, it is seen that a Man-in-the-Middle attack is in progress, wherein client device 402 has been fraudulently routed to anonymous proxy server 207 via a network connection 511, and thence via a connection 513 to validation server 500. (Because validation server 500 is the connection point for service provider server 505, a Man-in-the-Middle attack will be set up between client device 402 and validation server 500.) When connection 513 is opened, validation server 500 knows to open a connection 537 to service provider server 505, and is thus able to furnish the session login screen to client device 402.

Upon session login request by client device 402, validation server 500 determines that proxy 207 has IP address 515, from a network communication 517 which carries the session login request via connection 511 and connection 513 through anonymous proxy 207. At this point, however, it is not known to validation server 500 that anonymous proxy 207 is involved. To make this determination, validation server 500 then signals agent 501 to open a direct connection 533 from client device 402. Preferably, agent 501 has already been downloaded into client device 402 as previously discussed, but if, for any reason, agent 501 is not present, validation server 500 downloads agent 501 via connection 513 and connection 511, also as previously discussed. When signaling agent 501, validation server 500 also sends a client direct connection ID request 525 to agent 501 via a network communication 527. Upon receiving CDC ID request 525, agent 501 generates a client direct connection ID 529. Once again, details of the CDC ID process are discussed below.

When agent 501 opens connection 533, client direct connection ID 529 is sent in a network communication 535 to validation server 500. At the same time as receiving and validating client direct connection ID 529, validation server 500 determines from network communication 535 that client device 402 has IP address 311. By comparison of IP address 311 with IP address 515 (these do not match), validation server 500 determines that an anonymous proxy is in the connection, indicating that a Man-in-the-Middle attack is in progress.

According to a further embodiment of the present invention, after detecting the Man-in-the-Middle attack, validation server 500 blocks the attack by signaling agent 501 to terminate connection 511, and then terminating connection 513 as well as terminating connection 537. In yet another embodiment of the present invention (described below), upon detecting the Man-in-the-Middle attack, validation server 500 circumvents the attack. In still another embodiment of the present invention (also described below), validation server 500 preemptively circumvents a potential Man-in-the-Middle attack.

### Method for Detecting a Man-in-the-Middle Attack

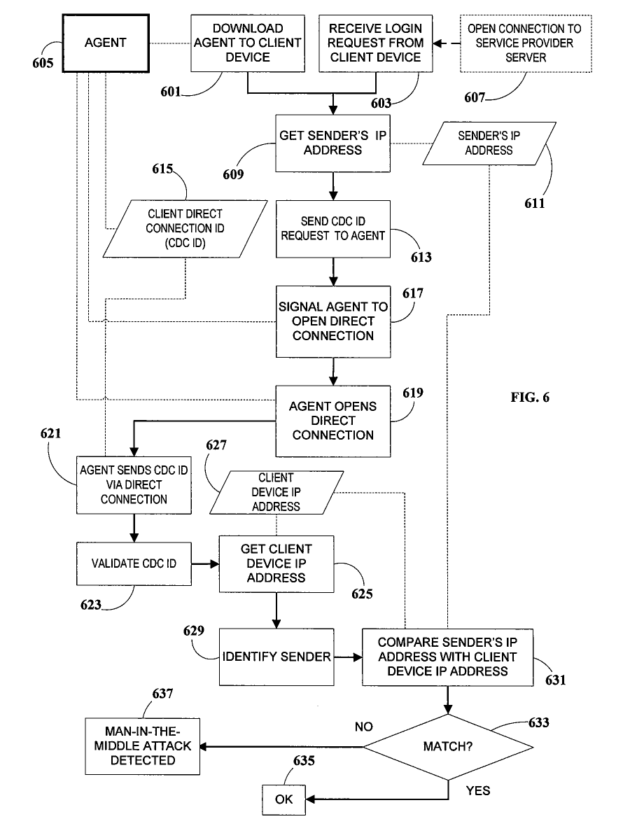

FIG. 6 is a flowchart of a method for detecting a Man-in-the-Middle attack according to an embodiment of the present invention.

For this particular embodiment, the specific security host depends on the configuration in the context of which the method is performed. FIG. 4 illustrates one such non-limiting configuration, wherein the security host is service provider server 400. FIG. 5B illustrates another such non-limiting configuration, wherein the security host is validation server 500. The distinction of the specific security host figures into the details of certain steps thereof, as noted where appropriate in the following discussion.

In a step 601, an agent 605 is downloaded to the client device. In a step 603, a session login request is received from the client device. As previously discussed, in an embodiment of the present invention, agent 605 is downloaded previous to session login request receiving 603; in another embodiment of the present invention, agent 605 is downloaded after session login request receiving 603. The relative sequence of step 601 and step 603 is therefore not necessarily predetermined.

In an optional step 607 a connection is opened to a service provider server. This step is optional, depending on the specific embodiment of the present invention which is being implemented. As illustrated in FIG. 4 and described previously, service provider server 400 directly implements the method of FIG. 6, and thus step 607 is not performed for a configuration as shown in FIG. 4. As illustrated in FIG. 5A and FIG. 5B and described previously, however, validation server 500 implements the method of FIG. 6 on behalf of service provider server 505, and therefore step 607 is performed for a configuration as shown in FIG. 5A or FIG. 5B. For the configuration shown in FIG. 5A (where there is no Man-in-the-Middle attack), step 607 opens connection 507 between validation server 500 and service provider server 505; for the configuration shown in FIG. 5B (where there is a Man-in-the-Middle attack), step 607 opens connection 537 between validation server 500 and service provider server 505. Optional step 607, if performed according to the configuration, is preferably performed right after the client device opens a connection with validation server 500.

Returning to FIG. 6, in a step 609, sender's IP address 611 is obtained. A non-limiting example of this is illustrated in FIG. 4, where IP address 411 is obtained from network communication 407.

Next, in a step 613, a request to generate a client direct connection ID 615 is sent to agent 605. The details of this procedure are discussed below, in the section “Client Direct Connection ID (CDC ID) and Validation thereof”.

Continuing, in a step 617, agent 605 is signaled to open a direct connection from the user's computer to the security host, and in a step 619 agent 605 opens the direct connection. Once again, the specific configuration determines the precise nature of this direct connection. In the non-limiting case where the configuration is as shown in FIG. 4, the security host is service provider server 400, and the direct connection opened is connection 403, which goes from client device 402 directly to service provider server 400. In the non-limiting case where the configuration is as shown in FIG. 5B, the security host is validation server 500, and the direct connection opened is connection 533, which goes from client device 402 directly to validation server 500.

In a step 621 agent 605 sends client direct connection ID 615 via the direct connection to the security host. In a step 623 the security host then validates client direct connection ID 615. The objectives of validation step 623 are discussed below in the section “Client Direct Connection ID (CDC ID) and Validation thereof”.

Continuing with the flow in FIG. 6, in a step 625 the client device's IP address 627 is obtained from the direct connection set up by agent 605 in step 621. This is also illustrated conceptually in FIG. 4 as being obtained from network communication 405 and in FIG. 5B as being obtained from network communication 535. Then, from the results of validation step 623, the sender is identified in a step 629, as noted in objective 2. in the following section “Client Direct Connection ID (CDC ID) and Validation thereof”.

Once the sender is identified, the sender's IP address 611 is compared with the client device IP address 627 in a step 631. Finally, a decision point 633 evaluates the result of the comparison. If the sender's IP address 611 matches the client device IP address 627, the connection is safe, and a verification 635 is issued. Otherwise, if there is no match, a Man-in-the-Middle attack notification 637 is issued. According to embodiments of the present invention, notification of a Man-in-the-Middle attack signals or allows further protective action to be taken, and is accomplished by measures including, but not limited to: signaling an alert; setting a data flag; sending a message; and terminating a network connection.

In embodiments of the present invention, upon issue of notification 637, the offending connections from the proxy server used in the Man-in-the-Middle attack (such as connection 427in FIG. 4, or connection 513 in FIG. 5B) are terminated, to block the Man-in-the-Middle attack. In addition, agent 401 (FIG. 4) or agent 501 (FIG. 5) is signaled to terminate connection 425 or connection 511, respectively, to completely isolate proxy server 207.

It is noted that by the use of validation server 500 (FIG. 5A and 5B) as detailed in the above-described embodiments, a multiplicity of service provider servers (such as service provider server 505, service provider server 506, and service provider server 508) can be supported without requiring any modification or upgrade of their network capabilities. All the measures required for handling Man-in-the-Middle attacks are embedded in validation server 500. This is a new and valuable feature provided by embodiments of the present invention.

### Client Direct Connection ID (CDC ID) and Validation Thereof

Embodiments of the present invention rely on authenticating that a particular network connection opened by a client device to a security host over a network is a direct network connection from the client device to the security host, i.e., that there is no Man-in-the-Middle. It is emphasized that the issue of authenticating a direct network connection (as particularly defined previously herein) is separate and distinct from that of authenticating the client to the server. Even in cases when the client is authenticated to the server and the SSL protocol is employed, if the connection between them is an indirect network connection (as particularly defined previously herein), the session is vulnerable to a Man-in-the-Middle attack. Thus, there is a need to authenticate a direct network connection between the client and the security host.

Embodiments of the present invention provide means of authenticating a direct connection opened by a client device to a security host. As noted above, this is not an authentication of the client device, but an authentication that the network connection opened by the client device to the security host is a direct network connection, as particularly defined herein.

Embodiments of the present invention provide a client direct connection ID (CDC ID), which, when validated by the security host, verify that a network connection opened by the client device to the security host is a direct network connection and therefore is secure against a Man-in-the-Middle attack.

It is first noted that if the client device opens a network connection using the valid IP address of the security host (or equivalently, a valid URL of the security host), the opened connection will be a direct network connection. Therefore, authenticating that the network connection was opened in such a manner authenticates that the network connection is a direct network connection.

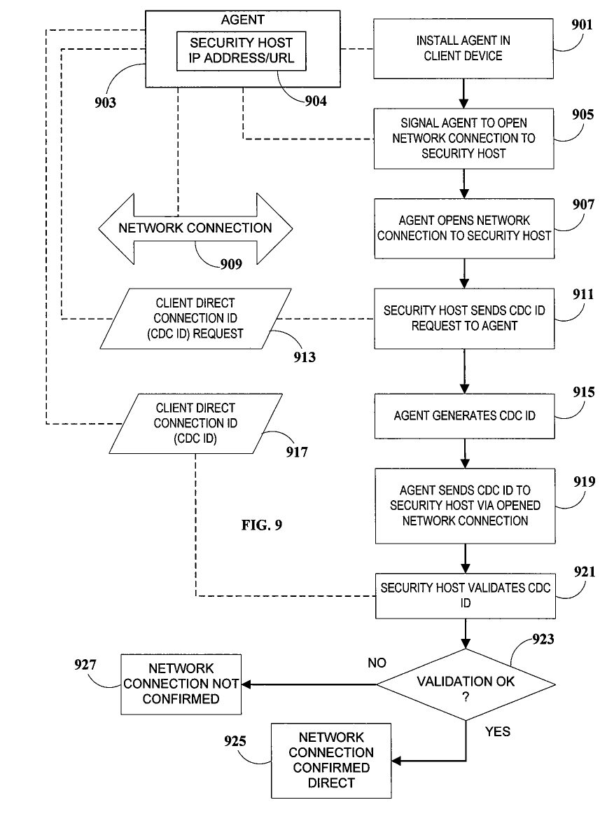

FIG. 9 is a flowchart of a method according to an embodiment of the present invention for authenticating a direct network connection 909 opened by a client device agent 903 to a security host, in order to establish that the network connection is not vulnerable to a Man-in-the-Middle attack.

In a step 901 agent 903 is installed in the client device. Preferably, this is done in advance in a secure manner, such as via a network connection that is known to be secure. This is discussed in further detail below, in the section “Security Levels for Client Direct Connection Authentication”. However, as noted previously in the section “Downloading of the Agent over an Indirect Network Connection”, a reasonable level of security can be attained even when installing agent 903 via a download over an indirect network connection.

Continuing the discussion of FIG. 9, in a step 905, agent 903 is signaled to open direct network connection 909 to the security host. In a step 907 network connection 909 is opened thereby. Because agent 903 contains the IP address 904 of the security host (or, alternatively, the URL of the security host), agent 903 is able to open a direct network connection 909 to the security host. As a result, an SSL connection over network connection 909 is not vulnerable to a Man-in-the-Middle attack. However, the security of network connection 909 has not yet been proven to the security host. In particular, the security host cannot yet verify that network connection 909 was in fact opened by agent 903 immediately after being signaled to do so.

To begin the verification process, in a step 911, the security host sends a CDC ID request 913 to agent 903, following which agent 903 generates a CDC ID 917 in a step 915. It is noted that the order of step 905 and step 911 is arbitrary and can be done in any order. Then in a step 919 agent 903 sends CDC ID 917 to the security host over network connection 909. In a step 921 the security host validates CDC ID 917, and the results of the validation are evaluated in a decision point 923. If the validation is successful, in a step 925, network connection 909 is confirmed as a direct connection and therefore secure against a Man-in-the-Middle attack. Otherwise, in a step 927, network connection 909 is not confirmed as a direct connection and is thus considered insecure, and possibly vulnerable to a Man-in-the-Middle attack.

In general, according to embodiments of the present invention, a CDC ID request is any data, message, or signal sent from the security host to the client device to which the client device responds by sending a CDC ID. Also in general, according to those embodiments of the present invention, a CDC ID is any data, message, or signal sent from the client device to the security host, by which the connection over which the CDC ID is sent is authenticated as a direct network connection. In preferred embodiments of the present invention, there is a functional relationship between the CDC ID request and the CDC ID; according to further preferred embodiments of the present invention, validation of the CDC ID by the security host regarding the functional relationship establishes that the network connection is a direct network connection, and is therefore not subject to the hazard of a Man-in-the-Middle attack.

In non-limiting embodiments of the present invention, CDC ID request 913 and CDC ID 917 are unique to the specific session and can include, but are not limited to any of the following or variations or combinations thereof:
a unique session ID which is assigned by the security host, sent to agent 903 as CDC ID request 913, and returned from agent 903 to the security host as CDC ID 917;
a one-time password (OTP) which is sent to agent 903 as CDC ID request 913 and returned as CDC ID 917—a random number is a non-limiting example of a one-time password;
a challenge-response interaction, where the challenge is CDC ID request 913, and the response is CDC ID 917, which is generated as function of CDC ID 913;
a digital certificate or similar data object, wherein CDC ID request 913 is timestamped and signed by the security host; and CDC ID 917 is CDC ID request 913 signed by agent 903;
or other suitable data that may be used to securely validate that connection 909 was opened by agent 903 immediately after receiving a signal to open a direct connection to the security host.

Validation of CDC ID 917 proceeds according to the specific nature thereof (as in the non-limiting examples presented above). In a non-limiting example, CDC ID request 913 is a timestamped data object which has been digitally signed by the security host and then sent to agent 903. Agent 903 then immediately digitally signs CDC ID request 913 and sends the signed data object to the security host over network connection 909. To validate CDC ID 917, the security host verifies that the received data object corresponds to the sequence just described, and that the transaction was completed in a reasonably-short amount of time.

Preferably, CDC ID request 913 and CDC ID 917 have at least the properties that CDC ID 917 is:
usable only once;
usable only within a limited time after receipt of CDC ID request 913 (such as on the order of the time necessary to open a network connection).

The above properties make CDC ID 917 secure against a replay attack and secure against many types of misappropriation. According to embodiments of the present invention, a client direct connection ID is not intended to authenticate the client or the client computer, but rather to identify and authenticate the network connection opened thereby to the security host—i.e., that the network connection opened by the agent in the user's computer, from the client device to the security host, is a direct network connection corresponding to a particular session login request, which is secure against a Man-in-the-Middle attack.

Embodiments of the present invention thereby provide a practical remedy for the lack of client authentication in the SSL protocol. Full client authentication is a separate matter handled by the service provider server; it is an objective of the present invention, however, to authenticate the network connection between client and server, to ascertain that there is no Man-in-the-Middle attack in progress; this objective is met by validating the client direct connection ID as disclosed herein.

The objective of validating the CDC ID is two-fold:
1. Principally, validation of the CDC ID guarantees that the connection from the client device to the security host is a direct connection (i.e., that there is no Man-in-the-Middle regarding this particular connection). The CDC ID is valid only when sent by the agent (605 as in FIG. 6); furthermore, the CDC ID is sent immediately over the direct connection which the agent has just opened. Thus it follows that validation of the CDC ID proves that the connection is a direct connection (i.e., this proves that there is no threat of a Man-in-the-Middle attack with this connection).
2. A secondary function of the CDC ID is to identify the sender of the session login request corresponding to a specific client device. The sender is the device from which the session login request has been sent to the security host. In the case of a direct connection from the client device to the security host, the client device is the sender. In the case of a Man-in-the-Middle attack, the sender is the proxy server. There may be a multiplicity of user session login requests at any particular instant, many of which will have corresponding direct connections opened by their respective agents. All of these need to be correlated, and this is done according to the results of the validation.

### Security Levels for Client Direct Connection Authentication

Embodiments of the present method rely on an agent which is installed in the client device (e.g., agent 401 in FIG. 4), and hence rely on the integrity of the installed agent. If the agent has been compromised by an attacker, the security of a method relying on that agent is also compromised.

Thus, it is important that the agent be installed in the client device in a secure manner. In preferred embodiments of the present invention, the installation of the agent in the user's computer is done in a manner by which the security of the installation can be verified independently. In a non-limiting example, the agent is installed via a download over a channel that is known to be secure; and the agent is persistent in the client device—i.e., the agent is pre-installed securely in the client device, before the client device opens a connection to a security host. It is noted that installation of the agent in the client device according to embodiments of the present invention is not restricted to being done by a security host, but can be accomplished in a secure manner by other facilities, particularly in cases where the agent is pre-installed. Receiving and validating a CDC ID generated by an installed agent, however, is generally done by a security host at the time a connection is opened. A secure pre-installation assures the highest security level for authenticating the client direct connection ID through the process of requesting, generating, and validating the CDC ID.

In certain circumstances, however, it may not be possible to securely pre-install the agent, and in the relevant embodiments of the present invention, the agent is therefore downloaded over a channel in which a Man-in-the-Middle attack may be in progress. In such a case, having the agent installed is clearly preferable to not having the agent installed. However, the security of such an arrangement is not as good as in the case of an agent that was previously installed under conditions known to be secure.

### Method for Circumventing a Man-in-the-Middle Attack

Embodiments of the present invention provide for circumventing Man-in-the-Middle attacks, rather than just detecting and blocking them. The terms “circumventing”, “circumvention”, and the like herein denote the taking of action to open or continue a session between a client device and a security host in such a way as to avoid, go around, remove, isolate, or eliminate a Man-in-the-Middle attack, as if the attack did not exist, and without any of the security hazards associated with the attack. The principal feature of circumvention is that upon detecting a Man-in-the-Middle attack the opened session between client device and security host is continued in a secure manner, rather than simply terminated. Thus, the attack is neutralized without interrupting the session and without disturbing the user. This is of advantage in eliminating inconvenience to the user and in maintaining user confidence in the ability of the network to handle sensitive information. It is noted that in the prior art, if a Man-in-the-Middle attack is detected, there is no alternative to simply terminating the connection in order to block the attack. As noted previously, this is a shortcoming of the prior art which causes inconvenience and concern to the user and undermines user faith in the safety of on-line transactions. In contrast, according to embodiments of the present invention, a detected Man-in-the-Middle attack is circumvented to maintain the session in a safe manner, and in such a way that the circumvention is not apparent to the user. The present invention, therefore, eliminates user inconvenience and concern and thereby maintains user faith in the safety of on-line transactions.

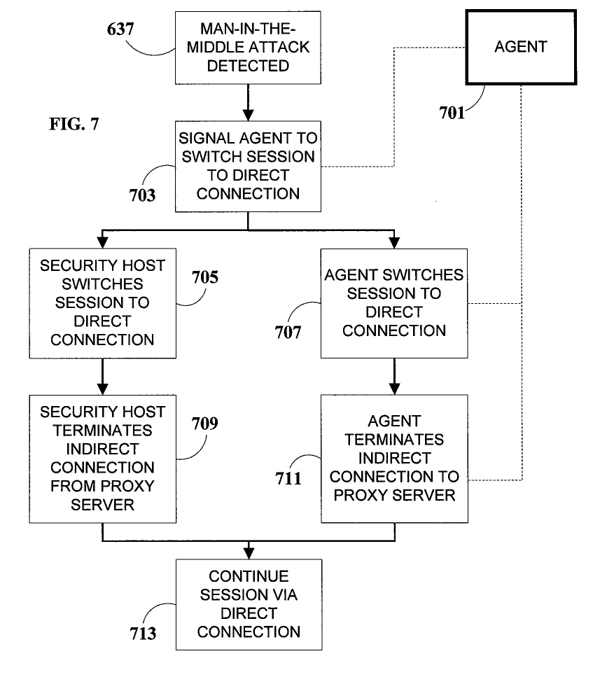

FIG. 7 is a flowchart of a method for circumventing a Man-in-the-Middle attack according to an embodiment of the present invention. This embodiment works in conjunction with a method for detecting a Man-in-the-Middle attack, including, but not limited to the previously-discussed method for detecting a Man-in-the-Middle attack. In step 637 a Man-in-the-Middle attack is detected (as illustrated in FIG. 6). In a step 703, an agent 701 (previously downloaded into the client device, as described earlier) is signaled to switch the current session to the previously-opened direct connection. Yet again, the specific configuration determines the precise nature of this direct connection. In the non-limiting case where the configuration is as shown in FIG. 4, the security host is service provider server 400, and the direct connection opened is connection 403, which goes from client device 402 directly to service provider server 400. In the non-limiting case where the configuration is as shown in FIG. 5B, the security host is validation server 500, and the direct connection opened is connection 533, which goes from client device 402 directly to validation server 500.

In a step 705, the attack handler switches the session to the direct connection, and in a step 709 terminates the connection from proxy server 207 (FIG. 4 or FIG. 5B). In a step 707 agent 701 switches the session to the direct connection and in a step 711 terminates the connection to proxy server 207. Steps 705/709 and steps 707/711 can be done simultaneously or in any order. When steps 709 and 711 have been completed, the session continues via the direct connection in a step 713.

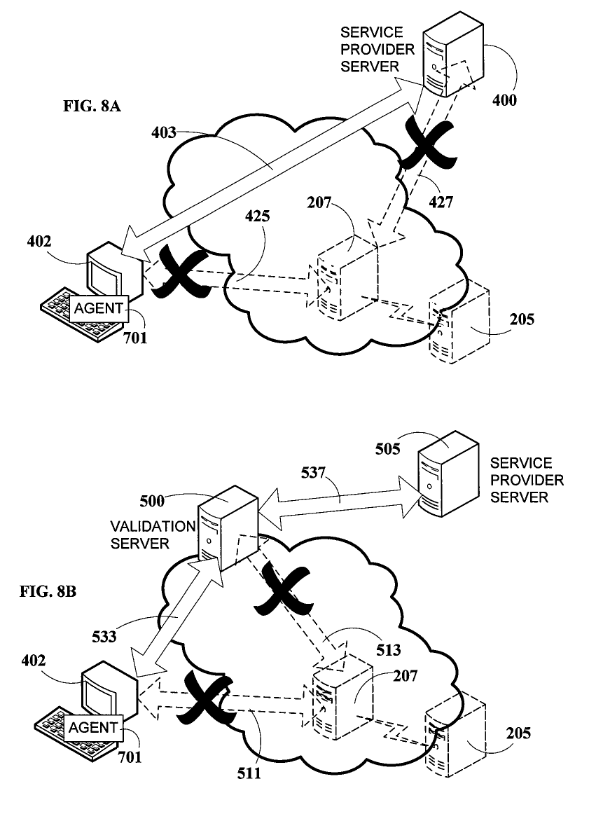

FIG. 8A corresponds to the configuration shown in FIG. 4, and conceptually illustrates the termination of connections 425 and 427 and the switch of the session to secure direct connection 403, thereby eliminating all data contact with proxy server 207 and circumventing the Man-in-the-Middle attack, while maintaining the session between client device 402 and service provider server 400. Likewise, FIG. 8B corresponds to the configuration shown in FIG. 5B, and conceptually illustrates the termination of connections 511 and 513 and the switch of the session to secure direct connection 533, thereby eliminating all data contact with proxy server 207 and circumventing the Man-in-the-Middle attack, while maintaining the session between client device 402 and validation server 500.

Up to this point the session involves only a session login request, and the transaction so far is prior to the sending of any sensitive information. Until the Man-in-the-Middle attack has been circumvented by switching the session to the secure direct connection and terminating all data connection to proxy server 207 conducting the attack, no sensitive information is transmitted. The session switching can be done in such a manner as to be unnoticeable by the user, who continues the session in a safe mode, free from eavesdropping by the attacker.

As noted previously, this seamless and transparent circumvention eliminates the problem of user inconvenience and loss of faith in the security of online transactions, as previously mentioned.

### Method for Preemptively Circumventing a Man-in-the-Middle Attack

Embodiments of the present invention also provide for preemptively circumventing a Man-in-the-Middle attack. The terms “preemptively circumventing”, “preemptive circumvention”, and the like herein denote the circumventing in advance of a potential Man-in-the-Middle attack, regardless of whether or not such an attack is actually taking place, can actually take place, or will actually take place. The advantage of these embodiments of the present invention is that there is no need to detect a Man-in-the-Middle attack. In other words, a session opened according to the preemptive circumvention provided by embodiments of the present invention is inherently immune to a Man-in-the-Middle attack.

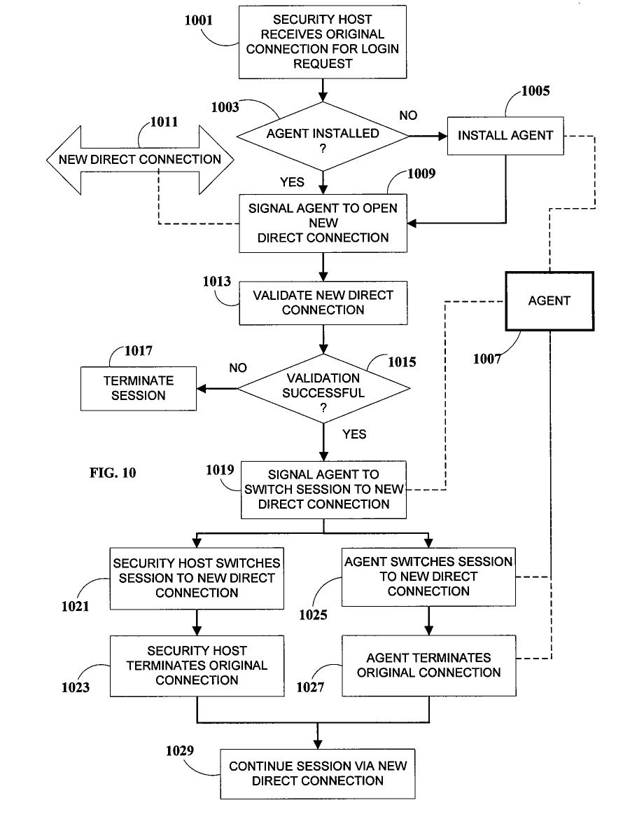

FIG. 10 is a flowchart of a method according to the present invention for preemptively circumventing a Man-in-the-Middle attack in a session between a client device and a security host. In a step 1001 the security host receives an original network connection opened by the client device for a session login request, for opening a session between the client device and the security host. Normally, the session would be conducted over the original network connection.

At a decision point 1003, the security host determines whether or not an agent is installed in the client device. In a non-limiting embodiment of the present invention, the determination is accomplished by sending a query signal to the client device, to which the agent is programmed to respond. If no response is received, the security host installs an agent 1007 in a step 1005. As noted previously, it is preferable that an agent be installed previously under secure conditions. If no agent is installed, however, step 1005 will perform the installation. Additionally, in other embodiments of the present invention, the agent responds to the aforementioned query signal with an identifying response that informs the security host of the version of the agent and whether or not it was previously installed in a secure environment. The security host can thus determine whether or not to update the agent installation.

After an agent has been determined to be present, in a step 1009 the security host signals the agent to open a new direct connection, which is subsequently done, resulting in new direct connection 1011. In a step 1013 the security host validates new direct connection 1011, such as by the non-limiting example, previously discussed for validating a new connection, in which step 1009 would have also included a CDC ID request.

At a decision point 1015, the success of the validation of step 1013 is examined, and if the validation was not successful, the session is terminated in a step 1017. If, however, the validation of step 1013 is successful, in a step 1019 the security host signals agent 1007 to switch the session from the original connection to new direct connection 1011. Subsequently, in a step 1021 the security host switches the session from the original connection to new direct connection 1011, and in a step 1023 terminates the original connection at the security host side. In parallel, the agent switches the session at the client device side from the original connection to new direct connection 1011 in a step 1025, and then terminates the original connection at the client device side in a step 1027.

After the session has been switched over on both sides from the original connection to new direct connection 1011 (which has been successfully validated in step 1013), the session is continued over new direct connection 1011 in a step 1029. Because the session is now over a validated direct connection, there is no threat of a Man-in-the-Middle attack, and thus any potential Man-in-the-Middle attack has been preemptively circumvented.

### Control Variations

In preferred embodiments of the present invention, the security host maintains control over the processes by signaling to the agent in the client device, such as by sending a CDC ID request, to which the agent responds with a CDC ID; or by signaling the agent to switch the session from the original network connection to the new direct connection.

In alternative embodiments of the present invention, however, the control is done via signaling by the agent to the security host for the above purposes.

While the invention has been described with respect to a limited number of embodiments, it will be appreciated that many variations, modifications and other applications of the invention may be made.

1. A method for detecting a Man-in-the-Middle attack during a session over a network connection between a client device having an IP address and a security host, the method comprising:
installing an agent within the client device, wherein said agent is configured to open a direct network connection to the security host;
receiving, by the security host, of an original network connection from the client device for a session login request, said original network connection having a sender with a sender IP address;
determining, by the security host, of said sender IP address;
sending, by the security host to said agent, a client direct connection ID request;
opening, by said agent, a new direct network connection from the client device to the security host;
generating, by said agent, a client direct connection ID in response to said request, and sending said client direct connection ID to the security host via said direct network connection;
determining, by the security host, of the IP address of the client device according to said new direct network connection;
comparing, by the security host, the IP address of the client device and said sender IP address according to said client direct connection ID; and
if according to said comparison said sender IP address does not match the IP address of the client device, then issuing a notification that a Man-in-the-Middle attack has been detected.

2. The method of claim 1, wherein said installing an agent within the client device is done prior to said receiving, by the security host, of an original network connection opened by the client device.

3. The method of claim 1, wherein said installing an agent within the client device is done subsequent to said receiving, by the security host, of an original network connection opened by the client device.

4. The method of claim 1, wherein the security host is a service provider server.

5. The method of claim 1, wherein the security host is a validation server providing protection for a service provider server against a Man-in-the-Middle attack.

6. The method of claim 1, further comprising validating said client direct connection ID by the security host.

7. The method of claim 1, further for blocking said Man-in-the-Middle attack, and further comprising, upon issuing a notification that a Man-in-the-Middle attack has been detected, terminating said original connection.

8. The method of claim 1, further for circumventing said Man-in-the-Middle attack, and further comprising:
signaling to switch the session to said new direct network connection;
switching, by the security host to said new direct network connection;
terminating, by the security host of said original network connection;
switching, by said agent to said new direct network connection;
terminating, by said agent of said original network connection; and
continuing the session over said new direct network connection.

9. A method for preemptively circumventing a Man-in-the-Middle attack during a session over a network connection between a client device and a security host, the method comprising:
installing an agent within the client device, wherein said agent is configured to open a direct network connection to the security host;
receiving, by the security host, an original network connection opened by the client device for the session between the client device and the security host;
signaling, by the security host, said agent to open a new direct network connection to the security host;
validating, by the security host, that said new direct network connection is a direct network connection;
signaling to switch the session from said original network connection to said new direct network connection;
switching, by the security host to said new direct network connection;
terminating, by the security host of said original network connection;
switching, by said agent to said new direct network connection;
terminating, by said agent of said original network connection; and
continuing the session over said new direct network connection.

10. The method of claim 9, wherein said installing an agent within the client device is done prior to said receiving, by the security host, of an original network connection opened by the client device.

11. The method of claim 9, wherein said installing an agent within the client device is done subsequent to said receiving, by the security host, of an original network connection opened by the client device.

12. The method of claim 9, wherein said validating further comprises:
sending, by the security host, a client direct connection ID request to said agent;
generating, by said agent, a client direct connection ID in response to said client direct connection ID request;
sending, by said agent, said client direct connection ID to said security host over said direct network connection;
receiving, by the security host, said client direct connection ID; and
validating, by the security host; said client direct connection ID.

13. A method for authenticating a network connection between a security host and a client device as a direct network connection, to protect against a Man-in-the-Middle attack, the method comprising:
installing an agent within the client device;
sending, by the security host, a client direct connection ID request to said agent;
opening, by said agent, a direct network connection to the security host;
generating, by said agent, a client direct connection ID in response to said client direct connection ID request;
sending, by said agent, said client direct connection ID to said security host over said direct network connection;
receiving, by the security host, said client direct connection ID; and
validating, by the security host; said client direct connection ID;
thereby authenticating said direct network connection as a direct network connection.
